(19) United States
(12) Patent Application Publication
(10) Pub. No.: US 2010/0244411 A1
(43) Pub. Date: Sep. 30, 2010

(54) AIRBAG SATELLITE

(75) Inventors: Markus Christoph, Regensburg (DE); Christian Plankl, Burgweinting (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/744,150

(22) PCT Filed: Nov. 20, 2008
(86) PCT No.: PCT/EP08/65895

§ 371 Date: May 21, 2010

(30) Foreign Application Priority Data
Nov. 22, 2007 (DE) 10 2007 056 227.8

(51) Int. Cl. B60R 21/20

(52) U.S. Cl. 280/728.2

(57) ABSTRACT

An airbag satellite is latched and/or suspended in a wall opening. The airbag satellite has a blockage element, which blocks a plug and which is implemented such that it allows the correct installation of the airbag satellite to be checked. The blockage of the plug by the blockage element is cancelled if the check shows that the airbag satellite is installed correctly.

Airbag satellites in the form of side air bag pressure satellites for example are known, these currently being secured in the vehicle by means of screws or rivets in the wet or dry space. Since these are safety-related components, it should be possible to ensure and document correct fitting.

Current side airbag satellites known from the prior art are designed to be secured in the vehicle by means of additional assembly means such as screws and rivets. Generally, as described above, they are secured in the vehicle in the door in the wet or dry space by means of screws or rivets. This mode of securing also serves to document fitting by the vehicle manufacturer by for example measuring and monitoring torque and/or the use of rivet pliers.

The housing is generally a plastic part and can alternatively also be designed for securing in the vehicle without additional assembly means, i.e. without screws or rivets. Securing can be effected for example by suspending or snapping into place the side airbag satellite or by securing the side airbag satellite by way of a type of bayonet lock, etc. However there is then no reliable documentation of fitting.

The object of the invention is therefore to provide an airbag satellite with simplified securing means, which can essentially dispense on the one hand with the use of screws or rivets and also permits documentation of fitting.

This object is achieved by an airbag satellite with the features of claim 1.

According to the invention therefore an airbag satellite to be latched and/or suspended in a wall opening is provided, the airbag satellite having a blocking element, which blocks a plug and is configured so that it allows verification of the correct installation of the airbag satellite, the blocking of the plug by the blocking element being canceled, if the verification shows that the airbag satellite is correctly installed.

The inventive airbag satellite here has the advantage that it can be suspended and/or latched into a wall opening. There is therefore no need for the use of screws or rivets to secure the airbag satellite, thereby reducing manufacturing and assembly costs. The airbag satellite also allows verification and documentation of whether or not it has been correctly assembled. To this end the inventive airbag satellite has a blocking element, which blocks a plug of the airbag satellite, so that it cannot be connected to a control unit of a vehicle, until it has been verified whether the airbag satellite has been correctly assembled in the vehicle. To this end the blocking element is configured to allow verification of the correct assembly of the airbag satellite and to cancel the blocking of the plug if it is determined that the airbag satellite is correctly installed. In this manner it is possible to determine simply and reliably whether the airbag satellite has been correctly assembled even though it has only been suspended and/or latched for securing purposes.

Advantageous embodiments and developments of the invention will emerge from the subclaims and the description with reference to the drawings.

In one inventive embodiment the airbag satellite has a snapper device with a snap hook element. The snapper device and/or the snap hook element is/are configured so that the airbag satellite can snap or latch in a wall opening to fix the airbag satellite in the wall opening. This has the advantage that the airbag satellite can be assembled quickly and economically in this manner and there is no need for screws and rivets, which would incur additional costs and would in particular be time-consuming to assemble.

In one advantageous development of the invention a strap with a predetermined breaking point is provided on the snap hook element as the blocking element. The strap here is formed so that it blocks or correspondingly covers the plug of the airbag satellite and only releases the plug when the strap is broken at the predetermined breaking point. This has the advantage that an operator cannot simply assemble the airbag satellite and connect the plug to a corresponding mating plug if it has not been verified whether the airbag satellite is correctly assembled.

In a further inventive development the strap with the predetermined breaking point is configured so that it breaks at a predefined tensile force, when the airbag satellite is correctly installed. In this instance the airbag satellite is positioned sufficiently securely in the wall so that the strap can break at the predetermined breaking point. However the strap does not break when the airbag satellite is incorrectly installed, as in this instance it is pulled out from its anchorage and “disassembled” by the tensile force.

In one advantageous development of the invention the broken strap can be inserted into the airbag satellite so that it blocks the snap hook element. This has the advantage that the airbag satellite cannot be disassembled because the snap hook is blocked. The airbag satellite can only be removed once the broken strap has been removed.

In a further advantageous development the broken strap can be inserted into the airbag satellite up to a predefined stop, the stop being selected for example so that it marks a desired end position of the airbag satellite. If the broken strap cannot be inserted up to the stop here, it can be determined that the airbag satellite is not correctly assembled as it has not reached its end position.

In a further inventive embodiment a wedge element with a predetermined breaking point is provided on the snap hook element as the blocking element. The wedge element here is configured so that it can block the plug of the airbag satellite and releases the plug when the wedge element is broken at the predetermined breaking point. To verify the correct assembly of the airbag satellite, the wedge element is subjected to a predefined compression force. If the wedge element breaks and can optionally also be inserted into the airbag satellite up to a predefined stop, the airbag satellite is correctly assembled or has reached its end position. If the wedge element does not break, because the airbag satellite as a whole has become detached from its holder, the airbag satellite is incorrectly assembled.

In a further inventive embodiment a tag with at least one predetermined breaking point and a strap to pull on is provided as the blocking element. The tag here initially covers the plug in an appropriate manner, so that it cannot be connected to a mating plug, it being possible advantageously for the strap to be formed on the outside of the plug. To verify the assembly of the airbag satellite, the tag or strap has to be pulled. It only tears, if the airbag satellite is correctly assembled and therefore positioned securely. If the airbag satellite is not assembled correctly however, the airbag satellite becomes detached from its anchorage when the strap is pulled and the strap does not tear. The tag has the advantage that it can be provided simply and economically as the blocking element.

For better documentation the blocking element and/or its removable part can be marked with a code, for example a data matrix code. This can be read in electronically and stored for documentation purposes. Alternatively or additionally the torn or broken off blocking element can also be retained for documentation purposes.

The invention is described in more detail below based on exemplary embodiments shown schematically in the figures in the drawings, in which:

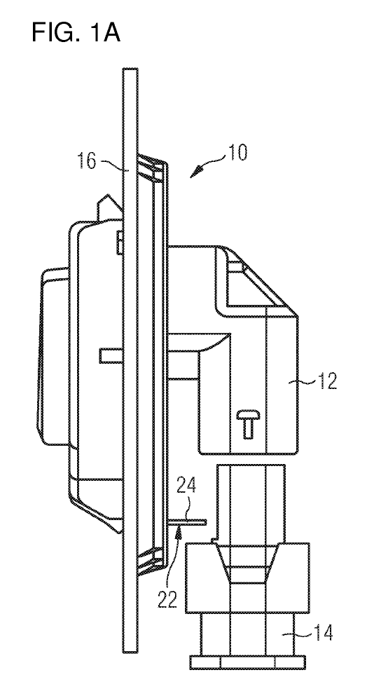

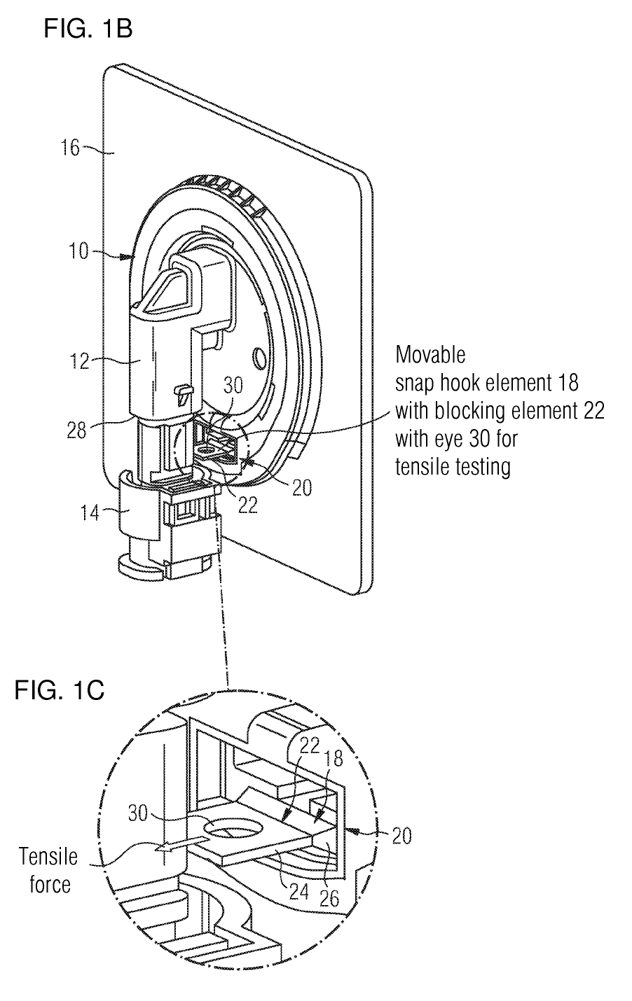

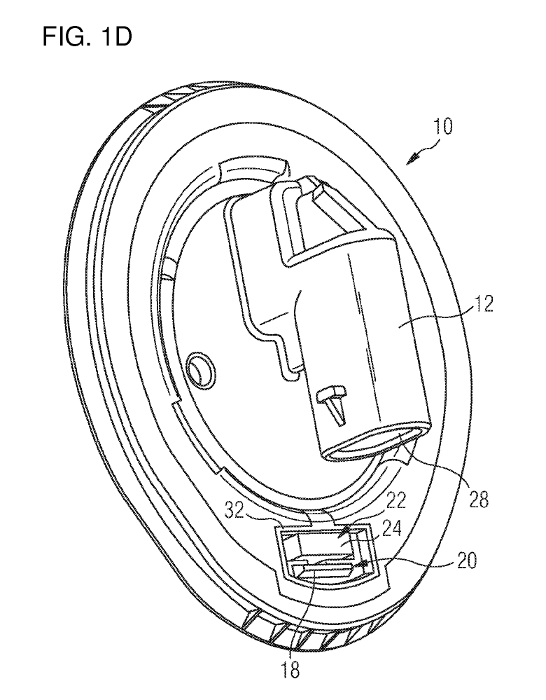

FIG. 1a shows a side view of a side airbag satellite according to a first embodiment of the invention, installed in a vehicle door;

FIG. 1b shows a perspective view of the installed side airbag satellite according to FIG. 1a;

FIG. 1c shows an enlarged section of a blocking element according to the first embodiment of the invention;

FIG. 1d shows a perspective view of the side airbag satellite according to FIG. 1, with the blocking element blocking a snap hook of the satellite;

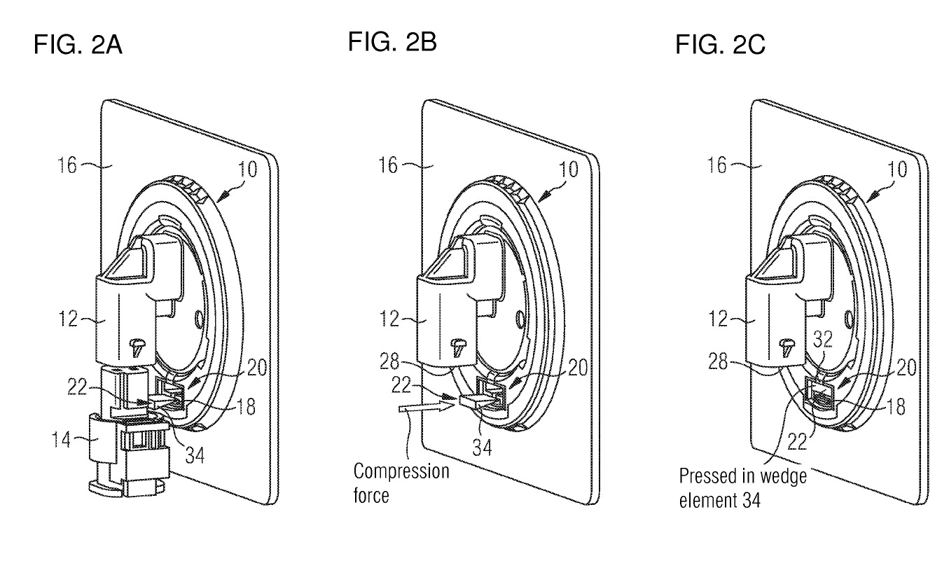

FIG. 2a shows a perspective view of an installed side airbag satellite according to a second embodiment of the invention;

FIG. 2b shows the side airbag satellite according to FIG. 2a, undergoing a compression test;

FIG. 2c shows the side airbag satellite according to FIG. 2a, a snap hook of the satellite being locked after the compression test;

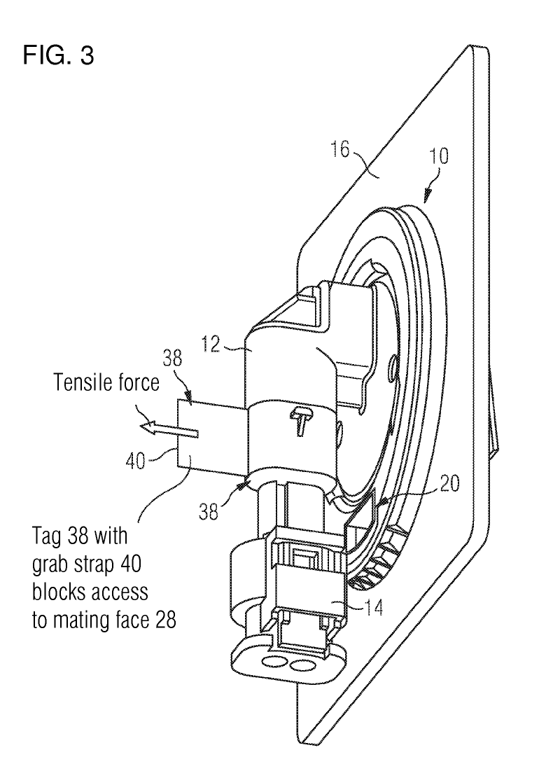

FIG. 3 shows a perspective view of an installed side airbag satellite according to a third embodiment of the invention.

Unless otherwise specified, identical elements and apparatuses and those with identical function have been assigned the same reference characters in all the figures. The present invention is described in more detail below based on the example of a side airbag satellite, which is installed for example in a vehicle door. However in principle the invention applies to all types of airbag and airbag satellite and the securing points of such airbags and airbag satellites. According to the invention airbags and corresponding airbag satellites are also included, which are fitted in the dashboard, steering wheel, vehicle pillars, floor, roof, doors, seats, headrests, etc., to name just a few examples.

FIG. 1a shows a side view of a side airbag satellite 10 according to a first embodiment of the invention installed in a vehicle door. The side airbag satellite 10 serves to detect at least one or more parameters, from which an impact can be concluded. For example the side airbag satellite 10 can detect a pressure difference or pressure change in the space where it is located, just to give one example of a plurality of parameters that can be determined by an airbag satellite. The invention is not restricted to this specific example but can be applied to all types of airbag and airbag satellite.

The side airbag satellite 10 forwards the parameters it determines for example to a central control facility (not shown), which analyzes this information for example and determines whether or not the side airbag is triggered. To this end the side airbag satellite 10 is connected to the central control facility. To this end the side airbag satellite 10 has a corresponding plug 12, which is connected to a corresponding mating plug 14 or is linked to the central control facility by way of the mating plug 14.

The inventive side airbag satellite 10 is then suspended or snapped in by way of a snap hook element 18 of a snapper device 20 of the satellite 10, as shown in FIGS. 1a to 1d, in the opening in a door, for example in a separating wall 16.

As shown in FIG. 1b and the enlarged section in FIG. 1c, the snapper device 20 or its snap hook element 18 can be extended by means of a blocking element 22, for example in the form of a strap 24, which has a predetermined breaking point 26. The strap 24 here is embodied so that it covers the access to the mating face 28 of the plug 12 at least partially or completely, as shown in FIGS. 1a and 1b, thereby preventing connection of the mating plug 14, until the correct installation of the side airbag satellite 10 has been verified. This also applies when the side airbag satellite 10 is correctly installed in the vehicle. It is first necessary to check correct installation, for example by means of a tensile test on the strap 24, before connection to the mating plug 14 is possible.

This can be done for example with the aid of a tool or a tensile testing device (not shown). To this end the strap 24 can for example also be provided with an opening 30, as shown in FIGS. 1b and 1c, from which a tensile testing device can be suspended. However this is merely an example and the invention is not restricted to this specific embodiment.

If the side airbag satellite 10 is fitted properly, as shown in FIG. 1d, the strap 24 breaks when a defined force is applied by the tensile testing device. This tensile force is for example lower than the maximum permissible force for the snap hook element 18. It is possible to determine by means of the tensile test whether the side airbag satellite 10 has been suspended correctly in the opening in the wall 16 and the snapper device is snapped in correctly. If the side airbag satellite 10 has not been fitted correctly however, in other words it is in a sort of semi-inserted or halfway snapped in position, so that although it initially remains in position in the vehicle, it could become loose during the course of its service life, the side airbag satellite 10 becomes detached from its anchorage during the tensile test, without the strap 24 breaking. In this instance the side airbag satellite 10 is in practice at least partially or essentially completely disassembled or detached from its original position by the tensile test. Assembly of the mating plug 14 can then be effectively prevented by the failure of the strap 24 to break.

Only after the side airbag satellite 10 has been correctly installed and the strap 24 has broken in the correct manner at its predetermined breaking point 26 during the tensile test, as shown in FIG. 1d, is connection of the mating plug 14 possible or permitted. It is possible in this manner to document and track whether or not the side airbag satellite 10 has been correctly installed.

The strap 24 can optionally also be marked with a data matrix code. The strap 24 can then be retained for documentation purposes or its content can be electronically read in and stored. This applies to all the inventive embodiments as described in more detail below.

It is also possible, as also shown in FIG. 1d, to clamp the torn off strap 24 after correct assembly and the obligatory tensile test between the movable snap hook element 18 and the stable side wall 32. This blocks the snap hook element 18, which can then no longer be actuated. The locked snap hook element 18 means that the side airbag satellite 10 cannot be removed in an unwanted manner. It can only be disassembled after the strap part has been removed.

Should it not be possible to reach the end position of the side airbag satellite 10, for example due to incorrect dimensioning at the installation site, the broken strap 24 cannot be pressed between the snap hook element 18 and a wall 32 of the airbag satellite 10, as shown in FIG. 1d (overdimensioning). In this manner it is also possible to determine and document that the side airbag satellite 10 is not correctly installed.

It is also not possible to break the strap 24 first and then clamp it between the snap hook element 18 and a side wall 32 of the airbag satellite 10 and then assemble the side airbag satellite 10 completely. The snap hook element 18 or the snapper device 20 can in this instance no longer be moved due to the inserted strap piece 24 and can therefore not be assembled with the side airbag satellite 10, since it cannot snap into the opening in the wall 16 and thus cannot secure the side airbag satellite 10 correctly therein.

In a further alternative embodiment the blocking element 22, in this instance the strap 24, can also be attached to the plug element 12 itself, covering the mating face 28 of the plug 12 to such a degree that the mating plug 14 cannot be connected to the plug 12. The mode of operation of the strap here is essentially identical to that of the strap 24 described above. A tensile test first has to be carried out on the strap. Only if the strap breaks as predetermined during this test can the side airbag satellite 10 be defined as correctly installed, in which process an additional verification can be carried out, by inserting the strap, as described above, between the snap hook element 18 and the wall 32.

A second inventive embodiment of the airbag satellite 10 is shown in FIGS. 2a to 2c.

As shown in FIG. 2a, a movable snapper device 20 is present on the side airbag satellite 10, being used to secure it in an opening in a wall 16. The snap hook element 18 can be embodied so that a blocking element 22 in the form of a type of wedge element 34 with a predetermined breaking point can also be configured on it.

The wedge element 34 is preferably embodied so that it covers the access to the mating face 28 of the plug 12 at least partially or completely, so that connection of the mating plug 14 is prevented, as shown in FIG. 2a.

In contrast to the first embodiment, the blocking element 22, in this instance the wedge element 34, is configured so that a compression test is carried out instead of a tensile test, to determine whether or not the side airbag satellite 10 is correctly installed.

Even if the side airbag satellite 10 is correctly fitted in the vehicle, the mating plug 14 can still not be assembled. A compression force first has to be applied to the wedge element 34, as shown in FIG. 2b.

If the side airbag satellite 10 is properly fitted, the wedge element 34 breaks at the predetermined breaking point when subjected to a predetermined, defined force. The wedge element 34 is then inserted and clamped between the movable snap hook element 18 and the stable wall 32, as shown in FIG. 2c. This blocks the snap hook element 18, which can then no longer be actuated. Only then is the path released for connecting the mating plug 14. Disassembly of the side airbag satellite 10 is again only possible after the wedge element 34 has been removed.

If the satellite 10 is in a semi-inserted position, so that although it is initially held in place in the vehicle wall 16, it could become loose during the course of its service life, it is finally pressed into the end position by the compression force additionally applied during the compression test and the wedge element 34 can slide into its end position.

However if it is not possible to reach the end position, for example due to incorrect installation dimensions at the installation site, the wedge element 34 cannot be pressed between the snap hook element 18 and the wall 32 (overdimensioning). This allows it to be determined and documented that the side airbag satellite 10 is not correctly installed.

It is also not possible to assemble the side airbag satellite 10 if the wedge element 34 is first broken, pressed in and then clamped between the snap hook element 18 and the wall 32. The snapper device 20 or the snap hook element 18 can then no longer be moved and the side airbag satellite 10 cannot be assembled, as the snapper device 20 cannot snap into the opening in the wall 16 as required.

FIG. 3 shows a third inventive embodiment of the inventive airbag satellite 10.

A blocking element 22 in the form of a tag 38 with at least one predetermined breaking point and a strap 40 for pulling is present on this side airbag satellite 10. The tag 38 is for example attached around the plug 12 or formed on it, as shown in FIG. 3, to prevent connection of the mating plug 14. Even if the side airbag satellite 10 is correctly fitted in the vehicle, the mating plug 14 cannot therefore be assembled first. A tensile test first has to be carried out on the tag 38 to determine and document that the side airbag satellite 10 is correctly assembled.

If the side airbag satellite 10 is properly fitted, in other words for example the snap hook element 18 of the snapper device 20 snaps into the wall opening 16 as required, the tag 38 tears when a defined force is applied, as the side airbag satellite 10 exercises a corresponding resistance due to its correct fitting in the wall opening 16. In other words the side airbag satellite 10 is positioned securely in the wall opening 16. The predefined tensile force acting on the tag 38 in the tensile test is for example lower than the maximum permissible force for the snap hook element 18. Only then is the path for connecting the mating plug 14 released, as the tag 38 is torn off, thereby allowing access to the mating face 28 of the plug 12.

If however the side airbag satellite 10 is in a semi-inserted or semi-assembled position, so that although it is initially held in position in the wall opening 16 in the vehicle, it could become loose during the course of its service life, it is disassembled or detached from its position by this tensile test, with the tag 38 not tearing off in the process, since the side airbag satellite 10 cannot offer enough resistance compared with when it is correctly assembled and securely positioned in the wall opening. The mating plug 14 can then not be assembled.

The tag 38 can also optionally be marked with a code, such as a data matrix code. The tag 38 can then be retained for documentation purposes or its content can be read in electronically and stored.

The advantages of the abovementioned embodiments are that securing elements, such as screws and rivets, are not required for additional documentation or additional testing of the assembly. Also the first to third embodiments for example only require a few individual parts, the costs of all three embodiments being relatively low, particularly compared with the known securing options with screws and rivets. The test method is also simplified.

Although the present invention was described above based on preferred exemplary embodiments, it is not restricted to these but can be modified in a diverse manner. The embodiments described above can be combined with one another in this process, in particular individual features thereof.

1-14. (canceled)

15. An airbag satellite to be one of latched and suspended in a wall opening, the airbag satellite comprising:
a plug; and
a blocking element for blocking said plug and configured so that said blocking element allows a correct installation of the airbag satellite to be verified, the blocking of said plug by said blocking element being canceled, if a verification shows that the airbag satellite is correctly installed.

16. The airbag satellite according to claim 15, further comprising a snapper device with a snap hook element which can at least one of snap and latch in the wall opening, to fix the airbag satellite in the wall opening.

17. The airbag satellite according to claim 16, further comprising a strap with a predetermined breaking point disposed on said snap hook element and functioning as said blocking element, said strap being configured so that it blocks said plug of the airbag satellite and releases said plug when said strap is broken at the predetermined breaking point.

18. The airbag satellite according to claim 17, wherein said strap with said predetermined breaking point is configured so that said strap breaks at a predefined tensile force, when the airbag satellite is correctly installed and does not break when the airbag satellite is incorrectly installed.

19. The airbag satellite according to claim 17, wherein when said strap is a broken strap, said broken strap can be inserted into the airbag satellite, up to a predefined stop, so that said broken strap blocks said snap hook element.

20. The airbag satellite according to claim 17, wherein if said strap can be inserted into the airbag satellite up to a predefined stop, the airbag satellite is correctly assembled and if said strap cannot be inserted into the airbag satellite up to the predefined stop, the airbag satellite is not correctly installed.

21. The airbag satellite according to claim 16, further comprising a wedge element with a predetermined breaking point disposed on said snap hook element and functioning as said blocking element, said wedge element being configured so that it blocks said plug of the airbag satellite and releases said plug when said wedge element is broken at the predetermined breaking point.

22. The airbag satellite according to claim 21, wherein said wedge element with the predetermined breaking point is configured so that said wedge element breaks at a predefined compression force and can optionally also be inserted into the airbag satellite up to a predefined stop when the airbag satellite is correctly installed and does not break and/or cannot be inserted up to the predefined stop when the airbag satellite is incorrectly installed.

23. The airbag satellite according to claim 15, further comprising a tag with at least one predetermined breaking point and a strap for pulling, said tag functioning as said blocking element.

24. The airbag satellite according to claim 23, wherein said tag is formed on an outside of said plug.

25. The airbag satellite according to claim 23, wherein said tag with the predetermined breaking point and said strap is configured so that said tag tears when a predefined tensile force is applied to said strap when the airbag satellite is correctly installed, thereby releasing said plug and does not tear when the airbag satellite is incorrectly installed.

26. The airbag satellite according to claim 15, wherein said blocking element has a removable part, at least one of said blocking element and said removable part is marked with a code which can be read in electronically and stored.

27. The airbag satellite according to claim 15, wherein said plug of the airbag satellite can be connected to a mating plug of a central control facility of a vehicle.

28. The airbag satellite according to claim 26, wherein said code is a data matrix code.

29. A vehicle, comprising:
at least one airbag satellite to be one of latched and suspended in a wall opening of the vehicle, said airbag satellite having a plug and a blocking element for blocking said plug and configured so that said blocking element allows a correct installation of said airbag satellite to be verified, the blocking of said plug by said blocking element being canceled, if a verification shows that said airbag satellite is correctly installed.
